(19) United States
(12) Patent Application Publication
(10) Pub. No.: US 2026/0019844 A1
(43) Pub. Date: Jan. 15, 2026

(54) METHOD AND APPARATUS FOR MOBILITY IN COMMUNICATION SYSTEM

(71) Applicant: Samsung Electronics Co., Ltd., Suwon-si (KR)

(72) Inventors: Kyoungmin PARK, Suwon-si (KR); Youngbum KIM, Suwon-si (KR); Jaewon LEE, Suwon-si (KR)

(21) Appl. No.: 19/268,905

(22) Filed: Jul. 14, 2025

(30) Foreign Application Priority Data
Jul. 12, 2024 (KR) 10-2024-0092623

(51) Int. Cl. H04W 24/08; H04W 36/30

(52) U.S. Cl. CPC H04W 24/08; H04W 36/304

(57) ABSTRACT

The disclosure relates to a 5G or 6G communication system for supporting a higher data transmission rate. According to an embodiment, a method performed by a user equipment (UE) in a communication system includes: receiving, from a serving cell, configuration information on uplink quality measurement reference signal corresponding to a neighbor cell; identifying that a mobility to the neighbor cell is triggered; transmitting, to the neighbor cell, the uplink quality measurement reference signal based on the configuration information; and receiving, from the neighbor cell, a first response message associated with whether the mobility is available, wherein whether the mobility is available is based on uplink quality corresponding to the uplink quality measurement reference signal.

### CROSS-REFERENCE TO RELATED APPLICATION

This application is based on and claims priority under 35 U.S.C. § 119 to Korean Patent Application No. 10-2024-0092623, filed on Jul. 12, 2024, in the Korean Intellectual Property Office, the disclosure of which is incorporated by reference herein in its entirety.

### BACKGROUND

### 1. Field

The present disclosure relates generally to a communication system, and more specifically to a method and an apparatus for mobility in a communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure provides a method and an apparatus for mobility in a communication system.

The present disclosure presents a target cell oriented mobility scheme.

The present disclosure proposes a simpler and faster handover procedure in a communication system.

The present disclosure minimizes coordination or cooperation between the base stations in charge of each cell, while also supporting handover that considers UL quality, which was difficult to consider in existing techniques. The technique presented in this disclosure can be applied to various environments and shows greater improvements especially in situations where coordination between a source cell and a target cell is limited, such as inter-RAT (radio access technology) handover.

The technical problems to be achieved in the present disclosure are not limited to the technical problems mentioned above, and other technical problems not mentioned will be clearly understood by a person who has ordinary skill in the technical field to which the present disclosure belongs from the description below.

A method according to one embodiment of the present disclosure for solving the above problems comprising: the terminal being permitted to apply the mobility technique presented by the source cell; the terminal determining and requesting handover to the target cell; the target cell reviewing and approving the terminal's request; link being established between the terminal and the target cell; the link between the terminal and the source cell being released.

According to an embodiment, a method performed by a user equipment (UE) in a communication system includes receiving, from a serving cell, configuration information on uplink quality measurement reference signal corresponding to a neighbor cell; identifying that a mobility to the neighbor cell is triggered; transmitting, to the neighbor cell, the uplink quality measurement reference signal based on the configuration information; and receiving, from the neighbor cell, a first response message associated with whether the mobility is available, wherein whether the mobility is available is based on uplink quality corresponding to the uplink quality measurement reference signal.

According to an embodiment, wherein the first response message includes an explicit indication whether the mobility is allowed by the neighbor cell, wherein in case that the uplink quality is equal to or higher than a first threshold, the explicit indication indicates that the mobility is allowed by neighbor cell, wherein in case that the uplink quality is lower than the first threshold, the explicit indication indicates that the mobility is not allowed by neighbor cell, and

wherein a value of the first threshold is predefined or information on the value of the first threshold is transmitted with the uplink quality measurement reference signal.

According to an embodiment, wherein the first response message includes information on the uplink quality.

According to an embodiment, wherein the method further includes in case that the uplink quality is equal to or higher than a second threshold: transmitting, to the neighbor cell, a handover confirmation message; and receiving, from the neighbor cell, a second response message associated with whether the handover is approved; and in case that the uplink quality is lower than the second threshold, transmitting, to the neighbor cell, a handover cancellation message, wherein a value of the second threshold is predefined or autonomously determined by the UE, or information on the value of the second threshold is received from the serving cell.

According to an embodiment, wherein the uplink quality measurement reference signal corresponds to a physical random access channel (PRACH) or a sounding reference signal (SRS), wherein the first response message corresponds to a random access response (RAR), wherein the handover confirmation message or the handover cancellation message is transmitted in a message 3 physical uplink shared channel (PUSCH) scheduled by the RAR, and wherein the second response message is received in a message 4 physical downlink shared channel (PDSCH).

According to an embodiment, wherein the configuration information includes information on at least one uplink quality measurement reference signal resource corresponding to the neighbor cell, and wherein the mobility to the neighbor cell being triggered is identified based on radio link quality measurements for mobility reference signals received from the serving cell and the neighbor cell.

According to an embodiment, a user equipment (UE) in a communication system includes a transceiver; and a processor coupled with the transceiver and configured to: receive, from a serving cell, configuration information on uplink quality measurement reference signal corresponding to a neighbor cell; identify that a mobility to the neighbor cell is triggered; transmit, to the neighbor cell, the uplink quality measurement reference signal based on the configuration information; and receive, from the neighbor cell, a first response message associated with whether the mobility is available, wherein whether the mobility is available is based on uplink quality corresponding to the uplink quality measurement reference signal.

According to an embodiment, wherein the first response message includes an explicit indication whether the mobility is allowed by the neighbor cell, wherein in case that the uplink quality is equal to or higher than a first threshold, the explicit indication indicates that the mobility is allowed by neighbor cell, wherein in case that the uplink quality is lower than the first threshold, the explicit indication indicates that the mobility is not allowed by neighbor cell, and

wherein a value of the first threshold is predefined or information on the value of the first threshold is transmitted with the uplink quality measurement reference signal.

According to an embodiment, wherein the first response message includes information on the uplink quality.

According to an embodiment, wherein the processor is further configured to: in case that the uplink quality is equal to or higher than a second threshold: transmit, to the neighbor cell, a handover confirmation message; and receive, from the neighbor cell, a second response message associated with whether the handover is approved; and in case that the uplink quality is lower than the second threshold, transmit, to the neighbor cell, a handover cancellation message, wherein a value of the second threshold is predefined or autonomously determined by the UE, or information on the value of the second threshold is received from the serving cell.

According to an embodiment, wherein the uplink quality measurement reference signal corresponds to a physical random access channel (PRACH) or a sounding reference signal (SRS), wherein the first response message corresponds to a random access response (RAR), wherein the handover confirmation message or the handover cancellation message is transmitted in a message 3 physical uplink shared channel (PUSCH) scheduled by the RAR, and wherein the second response message is received in a message 4 physical downlink shared channel (PDSCH).

According to an embodiment, wherein the configuration information includes information on at least one uplink quality measurement reference signal resource corresponding to the neighbor cell, and wherein the mobility to the neighbor cell being triggered is identified based on radio link quality measurements for mobility reference signals received from the serving cell and the neighbor cell.

According to an embodiment, a method performed by a base station in a communication system includes transmitting, to a user equipment (UE) on a serving cell, configuration information on uplink quality measurement reference signal corresponding to a neighbor cell; receiving, from the UE on the neighbor cell, the uplink quality measurement reference signal associated with the configuration information; identifying uplink quality based on the uplink quality measurement reference signal; and transmitting, to the UE on the neighbor cell, a first response message associated with whether the mobility is available, wherein whether the mobility is available is based on the uplink quality.

According to an embodiment, wherein the first response message includes an explicit indication whether the mobility is allowed by the neighbor cell, wherein in case that the uplink quality is equal to or higher than a first threshold, the explicit indication indicates that the mobility is allowed by neighbor cell, wherein in case that the uplink quality is lower than the first threshold, the explicit indication indicates that the mobility is not allowed by neighbor cell, and

wherein a value of the first threshold is predefined or information on the value of the first threshold is received with the uplink quality measurement reference signal.

According to an embodiment, wherein the first response message includes information on the uplink quality.

According to an embodiment, wherein the method further includes in case that the uplink quality is equal to or higher than a second threshold: receiving, from the UE on the neighbor cell, a handover confirmation message; and transmitting, to the UE on the neighbor cell, a second response message associated with whether the handover is approved; and in case that the uplink quality is lower than the second threshold, receiving, from the UE on the neighbor cell, a handover cancellation message, wherein a value of the second threshold is predefined or autonomously determined by the UE, or information on the value of the second threshold is transmitted to the UE on the serving cell.

According to an embodiment, a base station in a communication system includes a transceiver; and a processor coupled with the transceiver and configured to: transmit, to a user equipment (UE) on a serving cell, configuration information on uplink quality measurement reference signal corresponding to a neighbor cell; receive, from the UE on the neighbor cell, the uplink quality measurement reference signal associated with the configuration information; identify uplink quality based on the uplink quality measurement reference signal; and transmit, to the UE on the neighbor cell, a first response message associated with whether the mobility is available, wherein whether the mobility is available is based on the uplink quality.

According to an embodiment, wherein the first response message includes an explicit indication whether the mobility is allowed by the neighbor cell, wherein in case that the uplink quality is equal to or higher than a first threshold, the explicit indication indicates that the mobility is allowed by neighbor cell, wherein in case that the uplink quality is lower than the first threshold, the explicit indication indicates that the mobility is not allowed by neighbor cell, and

wherein a value of the first threshold is predefined or information on the value of the first threshold is received with the uplink quality measurement reference signal.

According to an embodiment, wherein the first response message includes information on the uplink quality.

According to an embodiment, wherein the processor is further configured to: in case that the uplink quality is equal to or higher than a second threshold: receive, from the UE on the neighbor cell, a handover confirmation message; and transmit, to the UE on the neighbor cell, a second response message associated with whether the handover is approved; and in case that the uplink quality is lower than the second threshold, receive, from the UE on the neighbor cell, a handover cancellation message, wherein a value of the second threshold is predefined or autonomously determined by the UE, or information on the value of the second threshold is transmitted to the UE on the serving cell.

The various embodiments of the present disclosure described above are only some of the preferred embodiments of the present disclosure, and various embodiments reflecting the technical features of the various embodiments of the present disclosure can be derived and understood by a person who has ordinary knowledge in the relevant technical field on the basis of the detailed description to be described below.

According to one embodiment of the present disclosure, it is possible to support superior mobility management performance compared to existing technologies through a simpler process.

The present disclosure proposes a simpler and faster handover procedure in a communication system.

The present disclosure minimizes coordination or cooperation between the base stations in charge of each cell, while also supporting handover that considers UL quality, which was difficult to consider in existing techniques. The technique presented in this disclosure can be applied to various environments and shows greater improvements especially in situations where coordination between a source cell and a target cell is limited, such as inter-RAT handover.

The effects obtainable in the present disclosure are not limited to the aforementioned effects, and other effects that are not mentioned can be clearly understood by a person who has ordinary skill in the art to which the present disclosure belongs from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the basic structure of a time-frequency resource domain in a wireless communication system.

FIG. 2 illustrates the time domain mapping structure and beam sweeping operation of a synchronization signal.

FIG. 3 illustrates the flow of signals for random access (RA).

FIG. 4 is a diagram illustrating a handover procedure of a communication system to which various embodiments of the present disclosure are applicable.

FIG. 5 is a diagram illustrating an example of a handover procedure of a communication system to which one embodiment of the present disclosure is applicable.

FIG. 6 is a diagram illustrating an example of a handover procedure according to one embodiment of the present disclosure.

FIG. 7 is a diagram illustrating an example of a handover procedure according to one embodiment of the present disclosure.

FIG. 8 is a diagram illustrating an example of the operation of a terminal according to one embodiment of the present disclosure.

FIG. 9 is a diagram illustrating an example of the operation of a target cell according to one embodiment of the present disclosure.

FIG. 10 illustrates a terminal transceiver according to one embodiment of the present disclosure.

FIG. 11 is a block diagram of a terminal according to one embodiment of the present disclosure.

FIG. 12 is a block diagram of a base station according to one embodiment of the present disclosure.

### DETAILED DESCRIPTION

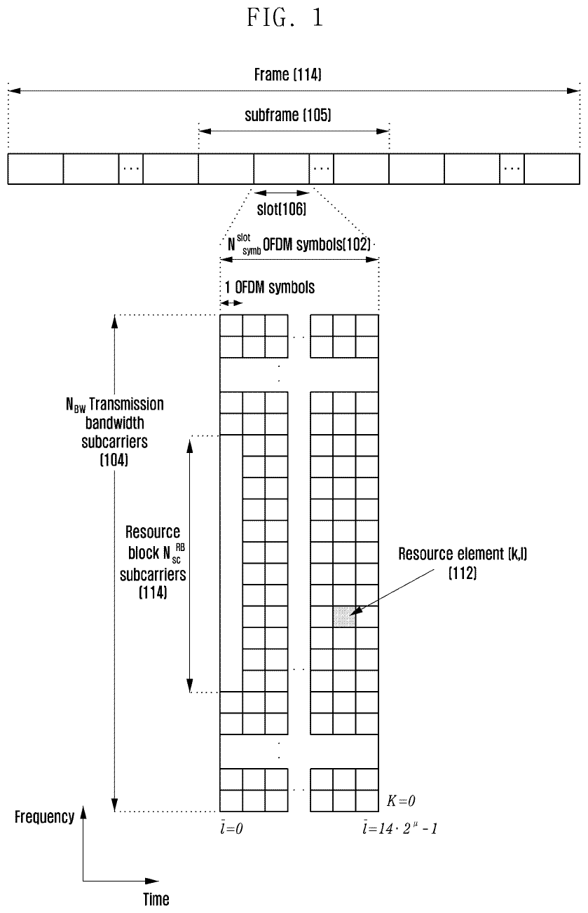

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operating principle of the present disclosure will be described in detail with reference to the attached drawings. In the following description of the present disclosure, in the case that it is determined that a specific description of a related known function or configuration may unnecessarily obscure the gist of the present disclosure, the detailed description thereof will be omitted. In addition, the terms described below are terms defined in consideration of the functions in the present disclosure, and these may vary depending on the intention or custom of the user or operator. Therefore, the definitions should be made on the basis of the contents throughout this specification.

In the following description of the present disclosure, in the case that it is determined that a specific description of a related known function or configuration may unnecessarily obscure the gist of the present disclosure, the detailed description thereof will be omitted. Hereinafter, embodiments of the present disclosure will be described with reference to the attached drawings.

The advantages and features of the present disclosure, and the methods for achieving them, will become clear with reference to the embodiments described in detail below together with the accompanying drawings. However, the present disclosure is not limited to the embodiments disclosed below, but may be implemented in various different forms, and the present embodiments are provided only to make the disclosure of the present disclosure complete and to fully inform those skilled in the art of the scope of the disclosure, and the present disclosure is defined only by the scope of the claims. The same reference numerals refer to the same components throughout the specification. In addition, when describing the present disclosure, in the case that it is determined that a specific description of a related function or configuration may unnecessarily obscure the gist of the present disclosure, the detailed description thereof will be omitted. In addition, the terms described below are terms defined in consideration of the functions in the present disclosure, and may vary depending on the intention or custom of a user or operator. Therefore, the definitions should be made on the basis of the contents throughout the specification.

Hereinafter, the base station is an entity that performs resource allocation of a terminal, and may be at least one of a gNode B, an eNode B, a Node B, a BS (Base Station), a wireless access unit, a base station controller, or a node on a network. The terminal may include a UE (User Equipment), an MS (Mobile Station), a cellular phone, a smartphone, a computer, or a multimedia system capable of performing a communication function. In the present disclosure, downlink (DL) refers to a wireless transmission path of a signal that a base station transmits to a terminal, and uplink (UL) refers to a wireless transmission path of a signal that a terminal transmits to a base station. In addition, although an LTE or LTE-A system may be described as an example below, embodiments of the present disclosure may be applied to other communication systems having a similar technical background or channel type. For example, the 5th generation mobile communication technology (5G, new radio, NR) developed after LTE-A may be included here, and the 5G below may be a concept that includes existing LTE, LTE-A, and other similar services. In addition, the present disclosure may be applied to other communication systems through some modifications without significantly departing from the scope of the present disclosure, as judged by a person who has skilled technical knowledge.

In this case, it will be understood that each block of the processing flowchart illustrations and combinations of the flowchart illustrations may be performed by computer program instructions. These computer program instructions may be mounted on a processor of a general purpose computer, a special purpose computer, or other programmable data processing equipment, such that the instructions, when executed by the processor of the computer or other programmable data processing equipment, create means for performing the functions described in the flowchart block(s). These computer program instructions may be stored in computer-usable or computer-readable memory that may be directed to a computer or other programmable data processing equipment to implement the functions in a specific manner, so that the instructions stored in the computer-usable or computer-readable memory may produce a manufactured item comprising instructional means for performing the functions described in the flowchart block(s). The computer program instructions may also be mounted on a computer or other programmable data processing equipment and a series of operational steps are performed on the computer or other programmable data processing equipment to create a computer-executable process, such that the instructions performing the computer or other programmable data processing equipment may also provide steps for performing the functions described in the flowchart block(s).

In addition, each block may represent a module, a segment, or a portion of code comprising one or more executable instructions for performing a specified logical function(s). It should also be noted that in some alternative embodiments, the functions recited in the blocks may occur out of sequence. For example, two blocks shown one after the other may in fact be performed substantially simultaneously, or the blocks may be performed in reverse order according to the functions they sometimes perform.

In this case, the term ‘˜unit’ used in the present embodiment refers to software or a hardware component such as a Field Programmable Gate Array (FPGA) or Application Specific Integrated Circuit (ASIC), which may perform any of the roles. However, ‘˜unit’ is not software or hardware specific. It may be configured to reside on an addressable storage medium, or it may be configured to execute one or more processors. Therefore, in one example, ‘˜unit’ includes components such as software components, object-oriented software components, class components, and task components, processes, functions, properties, procedures, subroutines, segments of program code, drivers, firmware, microcode, circuits, data, databases, data structures, tables, arrays, and variables. The functionality provided within the components and ‘˜units’ may be combined into fewer components and ‘˜units’, or further separated into additional components and ‘˜units’. Furthermore, the components and ‘˜units’ may be implemented to play one or more CPUs within the device or the security multimedia card. In addition, in the embodiment, ‘˜unit’ may include one or more processors.

FIG. 1 illustrates the basic structure of a time-frequency resource domain in a wireless communication system.

FIG. 1 is a diagram illustrating the basic structure of a time-frequency resource domain, which is a radio resource domain in which data or control channels of a 5G system are transmitted.

With reference to FIG. 1, the horizontal axis in FIG. 1 represents the time domain, and the vertical axis represents the frequency domain. The minimum transmission unit in the time domain of a wireless communication system is an OFDM (orthogonal frequency division multiplexing) symbol, in which

$${N}_{s y m b}^{slot}$$

symbols 102 may be grouped to form one slot 106, and

$${N}_{slot}^{subframe}$$

slots may be grouped to form one subframe 105. The length of a subframe is 1.0 ms, and 10 subframes may be grouped to form a 10 ms frame 114. The minimum transmission unit in the frequency domain is a subcarrier, and the bandwidth of the entire system transmission bandwidth may be composed of a total of NBW 104 subcarriers.

The basic unit of resources in the time-frequency domain is a resource element (RE) 112, which may be represented by an OFDM symbol index and a subcarrier index. A resource block (RB or physical resource block, PRB) may be defined as

$${N}_{s c}^{R B}$$

consecutive subcarriers 110 in the frequency domain. In the 5G system,

$${N}_{s c}^{R B} = 12 ,$$

and scheduling is performed for a terminal. The data rate may increase in proportion to the number of RBs.

In a wireless communication system, a base station may map data in RB units and perform scheduling on RBs that generally constitute one slot for a given terminal. That is, in a 5G system, the basic time unit in which scheduling is performed may be a slot, and the basic frequency unit in which scheduling is performed may be an RB.

The number of OFDM symbols

$${N}_{s y m b}^{slot}$$

is determined by the length of the cyclic prefix (CP) added to each symbol to prevent interference between symbols. For example, if the normal CP is applied, it can be

$${N}_{s y m b}^{slot} = 14 ,$$

and it the extended CP is applied, n can be

$${N}_{s y m b}^{slot} = 12.$$

The extended CP is applied to a system in which the radio transmission distance is relatively longer than the normal CP, and may maintain orthogonality between symbols. In the case of the normal CP, since the ratio of the CP length to the symbol length is maintained at a constant value, the overhead because of the CP may be maintained constant regardless of the subcarrier spacing. That is, if the subcarrier spacing is small, the symbol length becomes long, and thus the CP length may also become long. Conversely, if the subcarrier spacing is large, the symbol length becomes short, and thus the CP length may become short. The symbol length and CP length may be inversely proportional to the subcarrier spacing.

In wireless communication systems, various frame structures may be supported by adjusting the subcarrier spacing to satisfy diverse services and requirements. For example, from the perspective of the operating frequency band, a larger subcarrier spacing is advantageous for recovering from phase noise in higher frequency bands. From the perspective of transmission time, a larger subcarrier spacing shortens the symbol length in the time domain, and consequently shortens the slot length, which is advantageous for supporting ultra-low-latency service such as URLLC. From the perspective of cell size, a longer cyclic prefix (CP) allows for the support of larger cells, so a smaller subcarrier spacing may support relatively larger cells. A cell refers to the area covered by a single base station in a mobile communication.

Subcarrier spacing, CP length, etc. are essential information for OFDM transmission and reception. The base station and the terminal must recognize the subcarrier spacing, CP length, etc. as common values to enable smooth transmission and reception.

[Table 1] below illustrates the relationship between the subcarrier spacing configuration (μ), subcarrier spacing (Δf), and CP length supported in the 5G system.

TABLE 1

| | | Cyclic |
|---|---|---|
| μ | Δf = 2^{μ} · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |

[Table 2] below illustrates the number

$$( {N}_{s y m b}^{slot} )$$

of symbols per slot, the number

$$( {N}_{slot}^{frame , μ} )$$

of slots per frame, and the number

$$( {N}_{slot}^{subframe , μ} )$$

of slots per subframe for each subcarrier spacing configuration (μ) in the case of the general CP.

TABLE 2

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

[Table 3] below illustrates the number

$$( {N}_{s y m b}^{slot} )$$

of slots per frame, and the number

$$( {N}_{slot}^{frame , μ} )$$

of slots per frame, and the number

$$( {N}_{slot}^{subframe , μ} )$$

of slots per subframe for each subcarrier spacing configuration (μ) in the case of the extended CP.

TABLE 3
frame.st

| μ | N_{symb}^{slot} | Nₛₗₒₜ^{frame, μ} | Nₛₗₒₜ^{subframe, μ} |
|---|---|---|---|
| 2 | 12 | 40 | 4 |

In the early stages of the introduction of the 5G system, coexistence or dual mode operation with the existing LTE or/and LTE-A (hereinafter referred to as LTE/LTE-A) system was expected. As a result, the existing LTE/LTE-A may provide stable system operation to the terminal, and the 5G system may play a role in providing improved services to the terminal. Therefore, the frame structure of the 5G system should include at least the frame structure or essential parameter set of the LTE/LTE-A (e.g., subcarrier spacing=15 kHz).

For example, comparing a frame structure with a subcarrier spacing configuration μ=0 (hereinafter referred to as frame structure A) and a frame structure with a subcarrier spacing configuration μ=1 (hereinafter referred to as frame structure B), the frame structure B compared to frame structure A shows that the subcarrier spacing and RB size are twice as large, and the slot length and symbol length are twice as small. In the case of frame structure B, two slots may form one subframe, and 20 subframes may form one frame.

Generalizing the frame structure of the 5G system provides high scalability by ensuring that essential parameter sets such as subcarrier spacing, CP length, and slot length have integer multiple relationships for each frame structure. A subframe with a fixed length of 1 ms may be defined to represent a reference time unit that is independent of the frame structure.

The frame structure may be applied to correspond to various scenarios. From the perspective of cell size, since a longer CP length can support a larger cell, frame structure A may support a relatively larger cell than frame structure B. From the perspective of operating frequency band, a larger subcarrier spacing is advantageous for recovering phase noise in a high-frequency band, so frame structure B may support a relatively higher operating frequency than frame structure A. From the perspective of service, since a shorter slot length, which is the basic time unit of scheduling, is advantageous for supporting an ultra-low-latency service such as URLLC, frame structure B may be relatively more suitable for a URLLC service than frame structure A.

In the description of the present disclosure below, uplink (UL) may refer to a wireless link through which a terminal transmits data or a control signal to a base station, and downlink (DL) may refer to a wireless link through which a base station transmits data or a control signal to a terminal.

In the initial access stage where a terminal first accesses a system, the terminal may synchronize downlink time and frequency from a synchronization signal transmitted by a base station through cell search, and obtain a cell identifier (cell ID). The terminal may receive a physical broadcast channel (PBCH) using the obtained cell ID, and obtain a master information block (MIB), which is essential system information, from the PBCH. Additionally, the terminal may obtain cell-common transmission and reception-related control information by receiving system information (system information block, SIB) transmitted by the base station. The cell-common transmission and reception-related control information may include random access (RA)-related control information, paging-related control information, common control information for various physical channels, etc.

A synchronization signal is a signal that serves as a reference for cell search, and the subcarrier spacing may be applied to suit the channel environment, such as phase noise, for each frequency band. In the case of a data channel or a control channel, the subcarrier spacing may be adaptively applied according to the service type to support various services as described above.

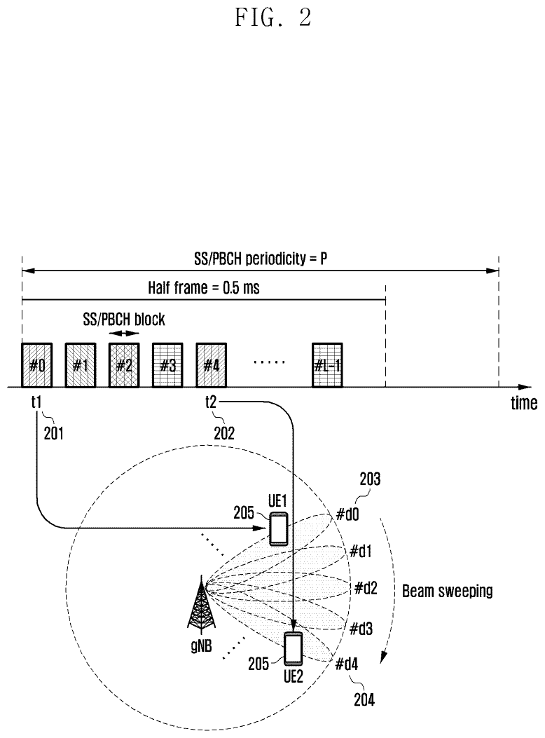

FIG. 2 illustrates the time domain mapping structure and beam sweeping operation of a synchronization signal.

Hereinafter, for the purpose of describing the present disclosure, the following components may be predefined:
Primary Synchronization Signal (PSS): It may provide some cell ID information as a signal that serves as the basis for DL time/frequency synchronization.
Secondary Synchronization Signal (SSS): It may serve as a reference for DL time/frequency synchronization and provide some of the remaining information of the cell ID. Additionally, it may serve as a reference signal (RS) for demodulation of PBCH.
Physical Broadcast Channel (PBCH): It may provide master information block (MIB), which is essential system information required for transmission and reception of data channels and control channels of the terminal. Essential system information may include information such as search space-related control information indicating radio resource mapping information of the control channel, scheduling control information for a separate data channel transmitting system information, and system frame number (SFN), which is a frame unit index that serves as a timing reference.
Synchronization Signal/PBCH (SS/PBCH) Block or SSB: An SS/PBCH block may be composed of N OFDM symbols and may include a combination of PSS, SSS, PBCH, etc. In the case of a system to which beam sweeping technology is applied, a SS/PBCH block may be the minimum unit to which beam sweeping is applied. In a 5G system, N may be 4. The base station may transmit maximum L SS/PBCH blocks, and the L SS/PBCH blocks may be mapped within a half frame (0.5 ms). The L SS/PBCH blocks may be periodically repeated in units of a predetermined period P. The period P may be notified to the terminal by the base station through signaling. In the case that there is no separate signaling for the period P, the terminal may apply a pre-agreed default value.

FIG. 2 illustrates an example in which beam sweeping is applied to SS/PBCH block units over time. In the example of FIG. 2, in the case of the terminal 1 205, the SS/PBCH block may be received using the beam radiated in the direction of #d0 203 by beamforming applied to SS/PBCH block #0 at time t1 201. Terminal 2 206 may receive the SS/PBCH block by using the beam radiated in the direction of #d4 204 by beamforming applied to SS/PBCH block #4 at time t2 202. The terminal may obtain the optimal synchronization signal through the beam radiated from the base station in the direction where the terminal is located. For example, it may be difficult for the terminal 1 205 to obtain time/frequency synchronization and essential system information from SS/PBCH blocks through beams radiating in the direction of #d4 204 at a distance from the location of the terminal 1 205.

In addition to the initial access procedure, the terminal may receive SS/PBCH blocks to determine whether the radio link quality of the current cell is maintained above a certain level. In addition, in a handover procedure in which the terminal moves connection from the current cell to a neighboring cell, the terminal may receive an SS/PBCH block of the neighboring cell to determine the radio link quality of the neighboring cell and obtain time/frequency synchronization of the neighboring cell.

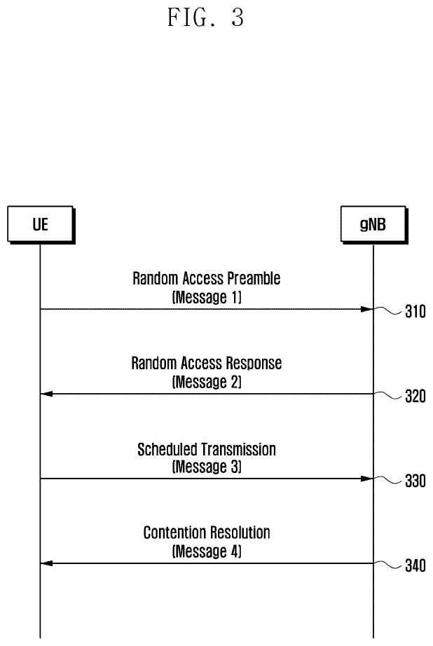

After obtaining MIB and system information from the base station through the initial access procedure, the terminal may perform a random access procedure to switch the link with the base station to a connected state (or RRC_CONNECTED state). Once the random access procedure is complete, the terminal may switch to the connected state (or RRC_CONNECTED state) and one-to-one communication between the base station and the terminal may be enabled. The random access procedure is described in detail with reference to FIG. 3 below.

FIG. 3 illustrates the flow of signals for random access (RA). FIG. 3 illustrates an example of a random access procedure, and the present disclosure is not limited thereto. In addition, the present disclosure is not limited to the four-step random access procedure illustrated in FIG. 3, but may also be applied to a two-step random access procedure (transmission and reception of message A (a message containing information corresponding to message 1 and message 3) and transmission and reception of message B (a message containing information corresponding to message 2 and message 4)).

With reference to FIG. 3, in step 310, the terminal may transmit a random access preamble to the base station. The random access preamble, which is the first transmission message of the terminal in the random access procedure, may be referred to as message 1. The base station may measure a transmission latency value between the terminal and the base station from the random access preamble and synchronize uplink. At this time, the terminal may arbitrarily select which random access preamble to use within a random access preamble set given by system information in advance. The initial transmission power of the random access preamble may be determined according to the path loss between the terminal and the base station measured by the terminal. In addition, the terminal may determine a transmission beam direction of the random access preamble from a synchronization signal received from the base station and transmit the random access preamble.

In step 320, the base station may transmit a random access response (RAR) (or message 2) for the random access preamble received at step 310. The base station may transmit an uplink transmission timing adjustment command to the terminal on the basis of the transmission latency value measured from the random access preamble. The base station may use scheduling information to determine the uplink resources and power to be used by the terminal. A control command may be transmitted to the terminal. The scheduling information transmitted by the base station may include control information for the uplink transmission beam of the terminal.

In the case that the terminal does not receive the random access response (RAR) (or message 2), which is the scheduling information for message 3 in step 320, from the base station within a predetermined time, step 310 may be performed again. In the case that step 310 is performed again, the terminal transmits the random access preamble by increasing the transmission power of the random access preamble by a predetermined step (e.g., power ramping), thereby increasing the odds of receiving the random access preamble from the base station.

In step 330, the terminal may transmit uplink data (i.e., message 3) including its terminal ID to the base station using the uplink resources allocated in step 320. The terminal may transmit uplink data including the terminal ID to the base station through the uplink data channel (physical uplink shared channel, PUSCH). The transmission timing of the uplink data channel for transmitting message 3 may follow the timing control command received from the base station in step 320. The transmission power of the uplink data channel for transmitting message 3 may be determined by considering the power control command received from the base station in step 320 and the power ramping value of the transmission power of the random access preamble. The uplink data channel for transmitting message 3 may mean the first uplink data signal that the terminal transmits to the base station after the terminal transmits the random access preamble.

In step 340, in the case that the base station determines that the terminal has performed random access without collision with other terminals, the base station may transmit data (i.e., message 4) including the ID of the terminal that transmitted uplink data in step 330 to the terminal. In the case that the terminal receives the signal transmitted by the base station in step 340 from the base station, the terminal may determine that the random access is successful. The terminal may transmit HARQ-ACK (hybrid automatic repeat request acknowledgement) information indicating whether message 4 was successfully received to the base station through a physical uplink control channel (PUCCH).

In the case that the data transmitted by the terminal in step 330 collides with data from another terminal and the base station fails to receive a data signal from the terminal, the base station may not transmit any more data to the terminal. In the case that the terminal fails to receive data transmitted from the base station in step 340 within a certain period of time, it may determine that the random access procedure has failed and may proceed again from step 310.

In the case that the terminal successfully completes the random access procedure, the terminal may be switched to the connected state or RRC_CONNECTED state and one-to-one communication between the base station and the terminal may be enabled. The base station may receive UE capability information from a terminal in the connected state or RRC_CONNECTED state and adjust the scheduling by referring to the UE capability information of the corresponding terminal. Through the UE capability information, the terminal may inform the base station of whether the terminal itself supports a certain function, the maximum allowable value of the function supported by the terminal, etc. Accordingly, the UE capability information reported by each terminal to the base station may have different values for each terminal.

For example, a terminal may report UE capability information including at least one of the following control information to a base station.
Control information related to frequency bands supported by the terminal
Control information related to channel bandwidth supported by the terminal
Control information related to the maximum modulation method supported by the terminal
Control information related to the maximum number of beams supported by the terminal
Control information related to the maximum number of layers supported by the terminal
Control information related to CSI reporting supported by the terminal
Control information on whether the terminal supports frequency hopping
Bandwidth-related control information when supporting carrier aggregation (CA)
Control information on whether cross carrier scheduling is supported when supporting carrier aggregation

In addition to the access procedure followed by the initial access procedure, the terminal requires a random access procedure to perform access to a neighboring cell in a procedure in which the terminal performs a handover from the current cell to a neighboring cell.

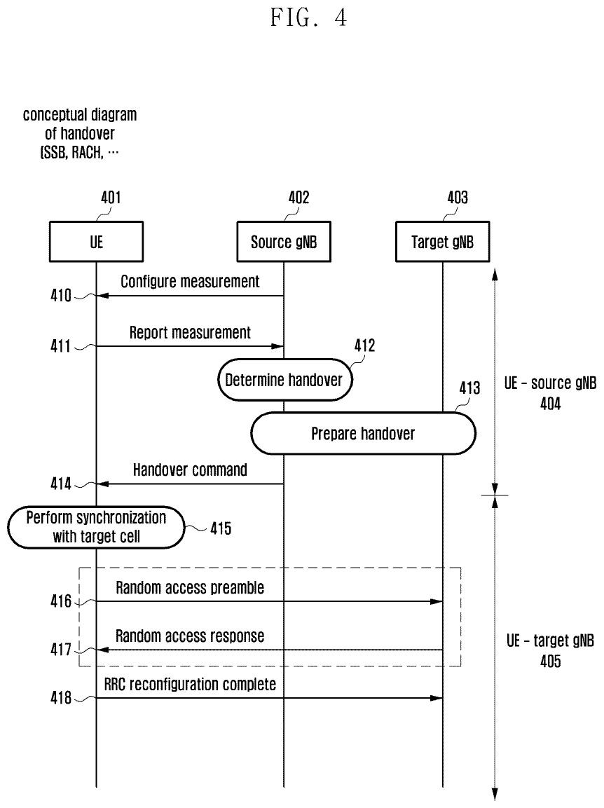

FIG. 4 is a diagram illustrating a handover procedure of a communication system to which various embodiments of the present disclosure are applicable.

Hereinafter, with reference to FIG. 4, a procedure for a terminal to perform a handover will be described. FIG. 4 illustrates a series of procedures in which a terminal communicating with the first base station (source gNB) changes its connection to the second base station (target gNB) through a handover procedure and performs communication. Unless otherwise specified, in the present disclosure, a base station and a cell have the same meaning. In special cases, one base station may be composed of multiple cells.

In step 410, the source gNB notifies and configures measurement-related control information for measuring the radio link quality of base stations surrounding the terminal to the terminal through signaling. The measurement-related control information includes at least a portion of the following control information.
Information about the reference signal of the surrounding base station that is the measurement target. For example, whether it is an SS/PBCH block or a CSI-RS.
Subcarrier spacing of the reference signal
Time/frequency domain location of the reference signal
Time/frequency domain size of the reference signal
Whether to report periodically or on the basis of a specific event when reporting measurement results measured by the terminal to the base station

The terminal measures the radio link quality between the terminal and the surrounding base station according to the measurement configuration from the source gNB.

In step 411, the terminal reports the measured radio link quality with the surrounding base station to the source gNB. In this case, the terminal is allocated UL resources required for the measurement report from the source gNB. The measurement report includes control information such as the cell ID of the surrounding base station measured by the terminal and radio link quality information of the corresponding cell.

In step 412, the source gNB refers to the measurement report of the terminal and determines whether to hand over the terminal to another base station.

When it is determined to hand over the corresponding terminal to the target gNB, in step 413, the source gNB prepares for the handover of the terminal by exchanging signaling between the target gNB and the base station. Step 413 includes a procedure in which the source gNB requests the handover of the terminal to the target gNB, a procedure in which the target gNB responds to the request, and a procedure in which the target gNB informs the source gNB of preliminary information required for the handover of the terminal.

When the handover preparation is completed between the source gNB and target gNB, the source gNB transmits a handover command to the terminal in step 414.

The procedure for changing the Radio Resource Control (RRC) connection configurations for a terminal in a connected state is called RRC reconfiguration. The handover is a type of RRC reconfiguration, and the base station instructs the handover command to the terminal by including detailed information called ‘reconfiguration WithSync’ in the ‘RRCReconfiguration’ RRC message. The handover command includes at least a portion of the following control information.
Cell ID of target gNB
Configuration information for common channels of target gNB
Information related to random access of target gNB
UE ID information to be used by the terminal in the target gNB

In step 415, the terminal performs DL time/frequency synchronization of the target gNB to disconnect from the source gNB and connect to the target gNB according to the received handover command. Therefore, the terminal maintains a connection state with the source gNB until step 415 (404), and from step 415 onwards, the terminal connects to the target gNB (405).

In step 416, according to the random access related information of the target gNB obtained by the terminal in step 414, the terminal transmits a random access preamble to the target gNB.

In step 417, the target gNB transmits a random access response signal for the preamble transmitted by the terminal to the terminal. The random access response signal includes time/frequency resource information required for UL transmission of the terminal in step 418.

In step 418, the terminal transmits an ‘RRCReconfigurationComplete’ message to the target gNB reporting successful completion of the handover procedure according to the random access response signal received from the target gNB.

Next, a method for estimating an uplink channel using a Sounding Reference Signal (SRS) transmission of a terminal is described. A base station may configure at least one SRS configuration for each uplink BWP to transmit configuration information for SRS transmission to a terminal, and may also configure at least one SRS resource set for each SRS configuration. As an example, the base station and the terminal may transmit and receive the following upper signaling information to transmit information about an SRS resource set.
srs-ResourceSetId: SRS resource set index
srs-ResourceIdList: A set of SRS resource indices referenced in the SRS resource set
resourceType: The time domain transmission configuration of an SRS resource referenced by an SRS resource set may be configured to one of ‘periodic’, ‘semi-persistent’, or ‘aperiodic’. In the case that resourceType is configured to ‘periodic’ or ‘semi-persistent’, associated CSI-RS information may be provided depending on the usage of the SRS resource set. In the case that resourceType is configured to ‘aperiodic’, a non-periodic SRS resource trigger list and slot offset information may be provided, and associated CSI-RS information may be provided depending on the usage of the SRS resource set.
usage: A configuration for the usage of the SRS resource referenced in the SRS resource set may be configured to one of ‘beamManagement’, ‘codebook’, ‘nonCodebook’, or ‘antennaSwitching’.
alpha, p0, pathlossReferenceRS, srs-PowerControlAdjustmentStates: Provides parameter configurations for adjusting the transmission power of SRS resources referenced in the SRS resource set.

The terminal may understand that the SRS resource included in the set of SRS resource indices referenced in the SRS resource set follows the information configured in the SRS resource set.

In addition, the base station and the terminal may transmit and receive upper layer signaling information to convey individual configuration information for the SRS resource. As an example, the individual configuration information for the SRS resource may include time-frequency domain mapping information within a slot of the SRS resource, which may include information about frequency hopping within a slot or between slots of the SRS resource. In addition, the individual configuration information for the SRS resource may include a time domain transmission configuration of the SRS resource, which may be configured to one of ‘periodic’, ‘semi-persistent’, and ‘aperiodic’. This may be restricted to have the same time domain transmission configuration as an SRS resource set including the SRS resource. In the case that the time domain transmission configuration of the SRS resource is configured to ‘periodic’ or ‘semi-persistent’, an SRS resource transmission period and slot offset (e.g., periodicityAndOffset) may be additionally included in the time domain transmission configuration.

The base station may activate, deactivate, or trigger SRS transmission to the terminal through higher layer signaling including RRC signaling or medium access control (MAC) control element (CE) signaling, or L1 signaling (e.g., DCI). For example, the base station may activate or deactivate periodic SRS transmission to the terminal through higher layer signaling. The base station may instruct the terminal to activate an SRS resource set in which resourceType is configured to periodic through higher layer signaling, and the terminal may transmit an SRS through an SRS resource referenced in the activated SRS resource set. Time-frequency domain resource mapping within a slot of the transmitted SRS resource follows resource mapping information configured in the SRS resource, and slot mapping including a transmission period and a slot offset follows periodicityAndOffset configured in the SRS resource. In addition, the spatial domain transmission filter applied to the transmitted SRS resource may refer to the spatial relation information configured in the SRS resource, or may refer to the associated CSI-RS information configured in the SRS resource set including the SRS resource. The terminal may transmit the SRS resource within the activated uplink BWP for the activated periodic SRS resource through upper layer signaling.

For example, the base station may activate or deactivate semi-persistent SRS transmission to a terminal through upper layer signaling. The base station may instruct to activate an SRS resource set through MAC CE signaling, and the terminal may transmit an SRS resource referenced in the activated SRS resource set. An SRS resource set activated through MAC CE signaling may be limited to an SRS resource set of which resourceType is configured to semi-persistent. Time-frequency domain resource mapping within a slot of a transmitted SRS resource follows resource mapping information configured in the SRS resource, and slot mapping including a transmission period and a slot offset follows periodicityAndOffset configured in the SRS resource. In addition, a spatial domain transmission filter applied to the transmitted SRS resource may refer to spatial relation info configured in the SRS resource, or may refer to associated CSI-RS information configured in an SRS resource set including the SRS resource. In the case that spatial relation info is configured in the SRS resource, the spatial domain transmission filter may be determined by referring to the configuration information for spatial relation info delivered through MAC CE signaling that activates semi-persistent SRS transmission without following it. The terminal may transmit the SRS resource within the activated uplink BWP for the semi-persistent SRS resource activated through upper layer signaling.

For example, the base station may trigger aperiodic SRS transmission to a terminal through DCI. The base station may indicate one of aperiodic SRS resource triggers (aperiodicSRS-ResourceTrigger) through an SRS request field of the DCI. The terminal may understand that an SRS resource set including an aperiodic SRS resource trigger indicated through DCI in an aperiodic SRS resource trigger list among configuration information of an SRS resource set is triggered. The terminal may transmit an SRS resource referenced in the triggered SRS resource set. Time-frequency domain resource mapping within a slot of the transmitted SRS resource follows resource mapping information configured in the SRS resource. In addition, the slot mapping of the transmitted SRS resource may be determined through a slot offset between a PDCCH including DCI and the SRS resource, and this may refer to value(s) included in a slot offset configured in the SRS resource set. Specifically, the slot offset between the PDCCH including DCI and the SRS resource may apply a value indicated in the time domain resource assignment field of the DCI among the offset value(s) included in the slot offset configured in the SRS resource set. In addition, the spatial domain transmission filter applied to the transmitted SRS resource may refer to the spatial relation info configured in the SRS resource, or may refer to the associated CSI-RS information configured in the SRS resource set including the SRS resource. The terminal may transmit the SRS resource within the activated uplink BWP for the aperiodic SRS resource triggered through the DCI.

In the case that the base station triggers an aperiodic SRS transmission to a terminal through DCI, a minimum time interval may be required between a PDCCH including the DCI triggering the aperiodic SRS transmission and the SRS to be transmitted, in order for the terminal to transmit the SRS by applying configuration information for the SRS resource. The time interval for the SRS transmission of the terminal may be defined as the number of symbols between the last symbol of the PDCCH including the DCI triggering the aperiodic SRS transmission and the first symbol to which the SRS resource to be transmitted is mapped first among the SRS resource(s) to be transmitted. The minimum time interval may be determined with reference to the PUSCH preparation procedure time required for the terminal to prepare for the PUSCH transmission. In addition, the minimum time interval may have different values depending on the usage of the SRS resource set including the SRS resource to be transmitted. For example, the minimum time interval may be determined as N2 symbols defined by considering the terminal processing capability according to the capability of the terminal with reference to the PUSCH preparation procedure time of the terminal. In addition, considering the usage of the SRS resource set including the SRS resource to be transmitted, in the case that the usage of the SRS resource set is configured to ‘codebook’ or ‘antennaSwitching’, the minimum time interval may be configured to N2 symbols, and in the case that the usage of the SRS resource set is configured to ‘nonCodebook’ or ‘beamManagement’, the minimum time interval may be configured to N2+14 symbols. The terminal transmits an aperiodic SRS in the case that the time interval for aperiodic SRS transmission is greater than or equal to the minimum time interval, and may ignore the DCI that triggers the aperiodic SRS in the case that the time interval for aperiodic SRS transmission is less than the minimum time interval.

TABLE 4
SRS- Resource ::= SEQUENCE {
srs-ResourceId SRS- ResourceId,
nrofSRS -Ports ENUMERATED { port1, ports2, ports4},
ptrs-PortIndex ENUMERATED {n0, n 1 } OPTIONAL, -- Need R
transmissionComb CHOICE {
n2 SEQUENCE {
combOffset-n2 INTEGER ( 0..1 );
cyclicShift-n2 INTEGER (0..7)
},
n4 SEQUENCE {
combOffset-n4 INTEGER (0..3),
cyclicShift-n4 INTEGER (0..11)
}
},
resourceMapping SEQUENCE {
startPosition INTEGER ( 0.. 5),
nrofSymbols ENUMERATED {n1, n2, n4},
repetitionFactor ENUMERATED {n1, n2, n4}
},
freqDomainPosition INTEGER ( 0.. 67);
freqDomainShift INTEGER ( 0.. 268 );
freqHopping SEQUENCE {
c-SRS INTEGER (0..63),
b-SRS INTEGER (0..3),
b-hop INTEGER ( 0.. 3)
},
groupOrSequenceHopping ENUMERATED { neither, groupHopping ,
sequenceHopping } ,
resourceType CHOICE {
aperiodic SEQUENCE {
...
},
semi-persistent SEQUENCE {
periodicityAndOffset-sp SRS- PeriodicityAndOffset ,
...
},
periodic SEQUENCE {
periodicityAndOffset -p SRS- PeriodicityAndOffset ,
...
}
},
sequenceId INTEGER ( 0.. 1023);
spatialRelationInfo SRS- SpatialRelationInfo OPTIONAL, -- Need R
...
}

The spatialRelationInfo configuration information in Table 4 refers to a reference signal and applies the beam information of the reference signal to the beam used for the SRS transmission. For example, the configuration of spatialRelationInfo may include information such as Table 5 below.

TABLE 5

SRS- SpatialRelationInfo ::= SEQUENCE {
servingCellId ServCellIndex OPTIONAL, -- Need S
referenceSignal CHOICE {
ssb -Index SSB-Index,
csi -RS-Index NZP-CSI-RS- ResourceId,
srs SEQUENCE {
resourceId SRS- ResourceId,
uplinkBWP BWP-Id
}
}
}

With reference to the spatialRelationInfo configuration, you may configure the index of the reference signal to be referenced to use the beam information of a specific reference signal, that is, the SS/PBCH block index, the CSI-RS index, or the SRS index. The upper signaling referenceSignal is configuration information indicating which beam information of a reference signal to refer to for the corresponding SRS transmission, and ssb-Index means the index of the SS/PBCH block, csi-RS-Index means the index of the CSI-RS, and srs means the index of the SRS, respectively. In the case that the value of the upper signaling referenceSignal is configured to ‘ssb-Index’, the terminal may apply the reception beam used when receiving the SS/PBCH block corresponding to ssb-Index as the transmission beam for the corresponding SRS transmission. In the case that the value of the upper signaling referenceSignal is configured to ‘csi-RS-Index’, the terminal may apply the reception beam used when receiving the CSI-RS corresponding to csi-RS-Index as the transmission beam for the corresponding SRS transmission. In the case that the value of the upper signaling referenceSignal is configured to ‘srs’, the terminal may apply the transmission beam used when transmitting the SRS corresponding to srs as the transmission beam for the corresponding SRS transmission.

Hereinafter, the upper layer signaling may be signaling corresponding to at least one or a combination of one or more of the following signaling.
MIB (master information block)
SIB (system information block) or SIB X (X=1, 2, . . . )
RRC (radio resource control)
MAC CE (medium access control control element)

In addition, L1 signaling may be signaling corresponding to at least one or a combination of one or more of the following physical layer channels or signaling methods.
PDCCH (physical downlink control channel)
DCI (downlink control information)
Terminal-specific DCI
Group common DCI
Common DCI
Scheduling DCI (e.g., DCI used for scheduling downlink or uplink data)
Non-scheduled DCI (e.g. DCI not intended for scheduling downlink or uplink data)
PUCCH (physical uplink control channel)
UCI (uplink control information)

Handover between cells or support for terminal mobility is a core technology in mobile communication. Generally, as the number of nodes involved in handover increases, or as the layer involved in control becomes higher, the processing time and latency required for handover tend to increase. In addition, since more careful handover management is required, it is generally difficult to start the handover process in a timely manner. Accordingly, various mobility techniques have been proposed to increase the accuracy and timeliness of decisions during handover, reduce interruption time, and increase the reliability of target cell selection. However, existing techniques have the common problem of having processes composed of too many steps and lacking consideration of UL quality. The present disclosure proposes a solution to the above problems.

The 6th generation (6G) network is expected to be composed of high-performance cells that have smaller cell coverage compared to 5th generation (5G) but provide greater cell capacity and higher data rates than 5G. High-performance cells may not be suitable for achieving national coverage. Therefore, the 6G network is expected to be configured in a way that simultaneously implements high-performance cells and other cells, such as low-capacity cells that are installed/configured using lower frequency bands and provide wider cell coverage instead of the lower performance in cell capacity and supported data rates compared to high-performance cells. Alternatively and/or additionally, the 6G network is expected to be configured to support interworking with existing networks such as 4th generation (4G)/5G, which provide wider cell coverage compared to high-performance cells.

Regardless of which of the two methods is used to configure the 6G network, high-performance cells with small cell coverage are recognized as a crucial element of the 6G network, and more frequent handovers are anticipated because of this small cell coverage. In addition, as these high-performance cells are expected to aim to support 6G-specific services, it is necessary to design handovers involving these high-performance cells in a way that prevents performance degradation during the handover process. Considering this, the present disclosure proposes a handover scheme that makes handover decisions faster than existing handover processes, ensures lower interruption times, and minimizes the impact on existing networks by considering the possibility of interworking with existing RATs.

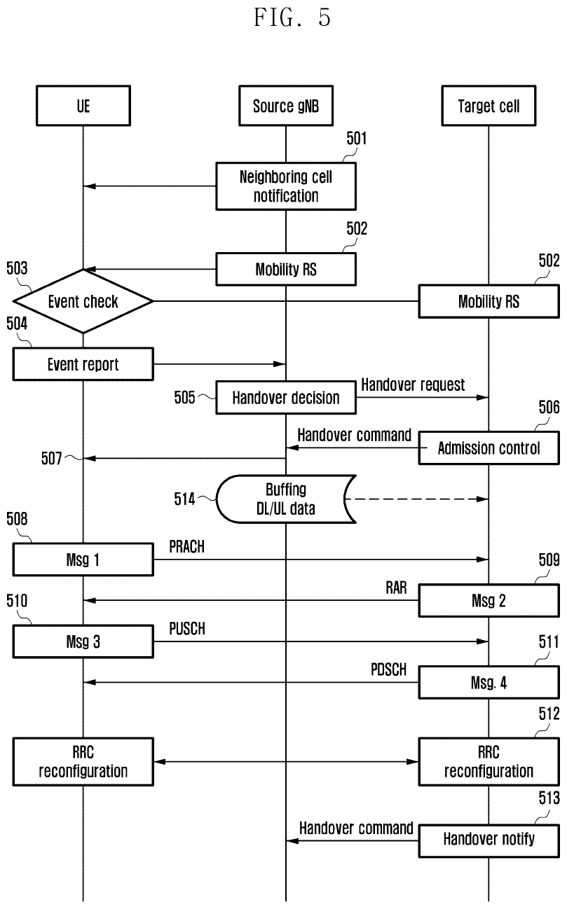

FIG. 5 is a diagram illustrating an example of a handover procedure of a communication system to which one embodiment of the present disclosure is applicable. More specifically, FIG. 5 is a diagram illustrating an example of a distributed network handover technique designed for long term evolution (LTE) and also used in 5G systems. Details that overlap with the explanation of handover described in FIG. 4 may be omitted, and the explanation of handover described in FIG. 4 may be referred to together.

With reference to FIG. 5, the source cell may share information about neighboring cells (and/or candidate cells. Unless otherwise specified, neighboring cells in this disclosure may be replaced by candidate cells and/or include candidate cells.) with the terminal (501). The terminal may perform cell-specific measurements for neighboring cells (502). The terminal may measure the radio link quality between the terminal and the surrounding base stations. For example, the terminal may measure the radio link quality on the basis of measurements of the Mobility RS (reference signal) for each of the source cell and the target cell.

Subsequently, in the case that a handover triggering event occurs (503), the terminal may report information about neighboring cells configured to be reported upon the triggering of the event, such as DL quality information, to the source cell (504). The occurrence of a handover triggering event may be identified on the basis of the cell-specific measurements described above. The source cell determines whether to perform a handover on the basis of the corresponding report and, in the case that it is determined that a handover is necessary, transmits this to the target cell in the form of a handover request (505). The target cell, among the multiple neighboring cells announced by the source cell to the terminal, is the cell selected by the source cell as the target for handover. Upon receiving the request, the target cell transmits a handover command to the source cell, indicating that it is ready to perform the handover (506). The source cell transmits the handover command to the terminal (507), after which the terminal performs a RACH procedure with the target cell and then performs an RRC reconfiguration operation after the RACH procedure is completed (508 to 512). The terminal may transmit msg1 to the target cell through physical random access channel (PRACH) (508), and the target cell may transmit msg2, i.e., RAR (509). The terminal may transmit msg3 through PUSCH (510), and the target cell may transmit msg4 through PDSCH. Subsequently, the terminal and the target cell may perform RRC reconfiguration (512). Once the RRC reconfiguration is complete, the entire handover process is completed, and the target cell transmits a handover notify to the original source cell (513). During the process where the terminal performs RACH with the target cell, the link with the source cell is released, and until the handover to the target cell is completed, the source cell buffers the user data for the corresponding terminal and then transmits the buffered user data to the target cell, i.e., the new source cell, so that it may be delivered to the terminal after the handover (514).

In the process of distributed network handover described above, event trigger condition determination is performed on the basis of L3 (layer 3) measurement, which has the disadvantage that it is impossible to determine whether an event has occurred in a timely manner and apply this to mobility management in an environment where link quality changes rapidly. As a solution to this, the LTM (low layer trigger mobility, layer 1/layer 2 (L1/L2) triggered mobility) technique has been proposed.

In LTM, instead of the terminal checking whether an event has occurred, it reports L1 (Layer 1) measurements for candidate cells selected from among neighboring cells, and the source cell reduces the decision delay by determining whether to perform a handover on the basis of these measurements.

In addition, as a measure to reduce the interruption time, which is the time interval during which data communication between the terminal and the network is interrupted, defined as the time interval from when the link with the source cell is released at the time of the handover decision to when the link with the target cell is established, methods have been developed in which the terminal performs the RACH procedure for the target cell before the handover decision of the source cell, receives the RRC information for the target cell, and, once the handover decision is made, quickly performs the handover using a cell switching command.

The methods have various advantages over basic distributed network handover techniques, but they also have several disadvantages, making it difficult to consider them as optimal handover techniques.

According to existing handover techniques, the source cell determines whether to perform a handover, and the handover is then performed through cooperation between the terminal and the target cell. However, the source cell may obtain only limited information about the target cell. For example, in the case of DL quality information, the source cell must rely on the information reported by the terminal after measurement. In the case that the source cell wishes to obtain more information about the DL between the target cell and the terminal, it must notify the terminal of the additional measurement and reporting configuration through coordination between the source cell and the target cell and receive the report accordingly. This requires an additional action called RRC configuration preparatory work and also involves some delay. In other words, the configuration for additional measurements and reporting must be configured as RRC configuration, and this may result in delay because of additional measurements and reporting from the terminal. In addition, the existing handover technique has the disadvantage that the source cell may not obtain information about the uplink quality between the target cell and the terminal. Furthermore, the process structure of the existing handover technique described above has the disadvantage that it requires multiple operations to support the source cell in securing the link quality of the target cell.

This disclosure presents a handover technique that solves the problems of the existing handover techniques described above, whereby the terminal first determines whether to perform a handover considering the DL quality of the target cell, and then the target cell directly determines whether to perform a handover.

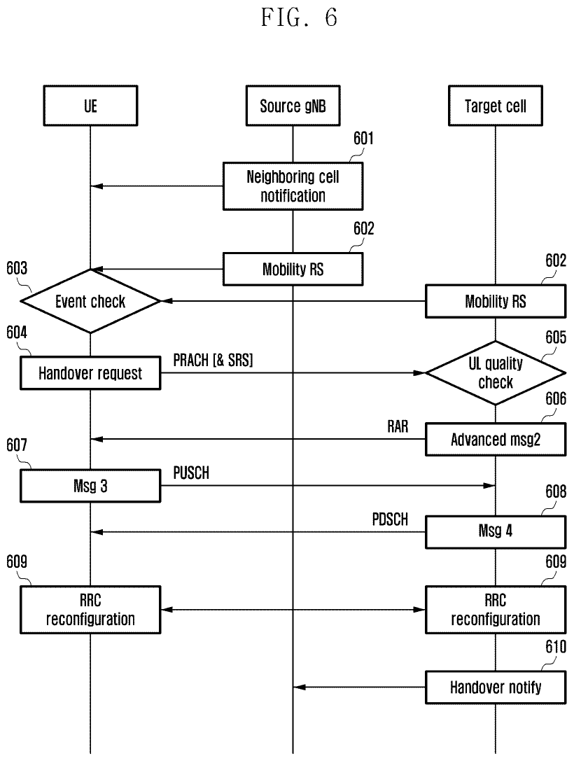

FIG. 6 is a diagram illustrating an example of a handover procedure according to one embodiment of the present disclosure. FIG. 6 is an example of an overall schematic diagram of a handover process according to one embodiment of the present disclosure. FIG. 6 illustrates an exemplary method that may be implemented according to the principles of the present disclosure, and various modifications may be made to the method illustrated in FIG. 6. For example, although illustrated as a series of steps, the various steps in each diagram may overlap, occur in parallel, occur in a different order, or occur multiple times. In other examples, steps may be omitted or replaced with other steps. Any details that overlap with the description of the handover described with reference to FIGS. 4 and 5 may be omitted, and the description of the handover described with reference to FIGS. 4 and 5 may be referred to together.

With reference to FIG. 6, a source cell may share neighboring cell information with a terminal (601).

The terminal compares the source cell DL quality and the target cell DL quality to determine whether to hand over and requests handover to the target cell through PRACH transmission (602 to 604). The terminal may measure the radio link quality between the terminal and the surrounding base stations. For example, the terminal may measure the radio link quality for each of the source cell and the target cell. The radio link quality may be measured on the basis of measurements for Mobility RS (602). In the case that an event that triggers a handover is identified on the basis of the measurement (603), the terminal may transmit a PRACH for a handover request to the target cell (604).
In performing the operation, the handover request may be configured to use specific PRACH radio resources or may be defined by the standard. At least some of the RO (RACH occasion) for PRACH transmission may be configured to be used for PRACH transmission for the handover request and/or may be defined by the standard.
In performing the operation, the terminal may transmit information about the UL quality required for handover to the target cell. The terminal may transmit information about the UL quality required for handover to the target cell together with and/or separately from the PRACH transmission for the handover request. This information transmission may be omitted.
In performing the operation, the terminal may support UL quality measurement of the target cell by transmitting additional UL quality measurement RS. UL quality measurement RS may use sounding reference signal (SRS), but this disclosure is not limited to this, and specific UL RS may be used. When the UL quality measurement RS is transmitted, the wireless resources used for the RS transmission may be determined by one or more of the following factors: the cell ID of the target cell, the PRACH wireless resources used in the request, or the SSB wireless resources used in selecting the PRACH wireless resources. The transmission of the UL quality measurement RS may be omitted.

The target cell recognizes the handover request from the terminal through receiving the request, and simultaneously performs UL quality measurement between the terminal and the target cell on the basis of PRACH and SRS or PRACH reception (605). The target cell may identify the handover request from the terminal by receiving PRACH for the handover request from the terminal. The target cell may perform UL quality measurement between the terminal and the target cell on the basis of the PRACH and/or UL quality measurement RS (SRS) for the handover request. On the basis of the measured UL quality, the target cell may determine whether to accept the terminal's handover request. For example, the target cell may determine whether to accept the handover request on the basis of the comparison result between the measured UL quality and a specific threshold. For example, in the case that the UL quality of the terminal that requested the handover request is above (or exceeds) the specific threshold, the target cell may determine that it can ensure sufficient UL quality for the terminal and determine to perform the handover. In the opposite case, it may determine not to perform the handover. The specific threshold may be the UL quality required for handover as transmitted from the terminal. Alternatively, the specific threshold may be predefined and/or defined by a standard.

The target cell informs the terminal whether or not to accept the terminal's handover request through RAR (606). For example, the RAR may include information about whether the handover request is accepted (i.e., whether the handover is permitted). Alternatively, in the case that specific information about acceptance of the handover request is included in the RAR, it may indicate that the handover request is accepted, and in the case that it is not included, it may indicate that the handover request is not accepted. Alternatively, the transmission of the RAR itself may indicate that the target cell accepts the handover request of the terminal.
When transmitting the RAR, the target cell may transmit information about UL quality to the terminal through the RAR. The target cell may transmit information about the measured UL quality to the terminal through the RAR. In the aforementioned 602 to 604, in the case that the terminal transmits information about the required UL quality to the target cell, the target cell may omit the transmission of information about the UL quality to the terminal in 606. Alternatively, the UL quality information may be excluded from the RAR at the discretion of the target cell. Alternatively, in the aforementioned steps 602 to 604, in the case that the required UL quality information is not transmitted to the target cell, the target cell may request the terminal to report the required UL quality information through the RAR.

The terminal transmits msg3 to the target cell through PUSCH in response to RAR (607). The terminal may also transmit information about the source cell to the target cell through this operation. For example, it transmits information such as the source cell PCID (physical cell ID) that enables the target cell to define/identify the source cell to the target cell. This information may be transmitted through msg3 PUSCH and/or separately.

Through operation 606, the target cell transmits information about UL quality to the terminal, and in the case that the terminal determines that the UL quality is inappropriate, the terminal may transmit a handover cancelled message to the target cell through operation 607. When the terminal receives information about the measured UL quality from the target cell and determines that the received UL quality is inappropriate (for example, this may be determined by comparing the received UL quality with a specific threshold value; for example, in the case that the UL quality received from the target cell is below (or equal to) a specific threshold value), the UL quality may be determined to be inappropriate. In the opposite case, the UL quality may be determined to be appropriate. The specific threshold may be configured by the base station and notified to the terminal, determined arbitrarily by the terminal, and/or defined in a standard. Additionally, the specific threshold used in the terminal operation may be a different value or parameter from the threshold used by the target cell for UL quality measurement (605). A handover cancelled message may be transmitted to the target cell through msg3 PUSCH. In the case that the handover cancelled message is transmitted to the target cell, the target cell does not perform the handover processes according to the embodiments of the present disclosure thereafter, and the handover process is terminated.

Alternatively, the terminal may transmit information about the required UL quality to the target cell through operation 607. For example, in the case that the terminal does not transmit the required UL quality information to the target cell in steps 602 to 604, it may transmit this information to the target cell through operation 607. In other words, the terminal may transmit the required UL quality information to the target cell through msg3 PUSCH.

The target cell transmits msg4 to the terminal through PDSCH in response to the terminal transmission in step 607. The target cell may transmit the final approval status of the handover to the terminal through msg4 PDSCH transmission. For example, msg4 may include information on the final approval status of the handover. Alternatively, in the case that specific information regarding approval of the handover is included in msg4, it may indicate that the handover has been approved, and in the case that it is not included, it may indicate that the handover request has not been permitted. Alternatively, the transmission of msg4 itself may indicate the target cell's approval of the terminal's handover. For example, in the case that the required UL quality received through step 607 is higher than the UL quality that the target cell can support, the target cell may reject the handover through msg4 PDSCH or inform the terminal that a reduction in UL quality is necessary. In the case that the target cell communicates to the terminal that a reduction in UL quality is necessary, it may transmit information about the reduced UL quality or the supported UL quality to the terminal through msg4 PDSCH.

Although not illustrated, after operation 607, the terminal may transmit the final approval status of the handover process to the target cell. Additionally, in the case that RRC reconfiguration is required, RRC reconfiguration operations are performed between the target cell and the terminal (609). The target cell may transmit a handover notify message to the source cell before or after performing RRC reconfiguration on the basis of the source cell information obtained through operation 607 (610). User data that was being transmitted and received through the source cell is transferred to the target cell through the transmission of the handover notify message and/or the transmission of the related message to the upper network node. In other words, the handover process may be completed without interruption time or user data buffering by the source cell.

In performing the target cell oriented handover process according to the embodiment described above, the following operations may be added. The source cell may configure neighboring cells and/or candidate cells for the terminal, and may notify the terminal of whether the target cell oriented handover process is supported at the same time as the configuration or as separate information. For example, when configuring neighboring cells or candidate cells for the terminal, the source cell may notify or configure the terminal of whether the target cell oriented handover process is supported for each neighboring cell or candidate cell. On the basis of the information, the terminal may request the target cell oriented handover process only for cells that support the target cell oriented handover process. And/or, the source cell may transmit to the terminal, in the form of cell-specific information, whether the source cell has or does not have the target cell oriented handover support function. And/or, in the case that the source cell determines that support for target cell oriented handover is not feasible, for example, when traffic is concentrated in some cells and cell-to-cell load balancing is more important than the link quality of each terminal, the source cell may notify the terminal that target cell oriented handover is disabled, regardless of the source cell's capabilities. The notification may be transmitted to the terminal in various forms, such as PDSCH, PBCH, or system information block (SIB). Conversely, in the case that the environment changes to a situation where target cell oriented handover support is feasible, such as when cells are in a low traffic load situation and can focus on ensuring optimal link quality for each terminal, this may be notified to the terminal, and the notification may be delivered to the terminal in various formats such as PDSCH, PBCH, and SIB. In other words, the source cell may notify the terminal that target cell oriented handover is enabled. Furthermore, for each target cell or candidate cell, the support status for the target cell oriented handover process may be dynamically adjusted in real time. Therefore, unless otherwise specified, the capability for target cell oriented handover in this disclosure may be understood to include cases where target cell oriented handover is enabled or disabled.

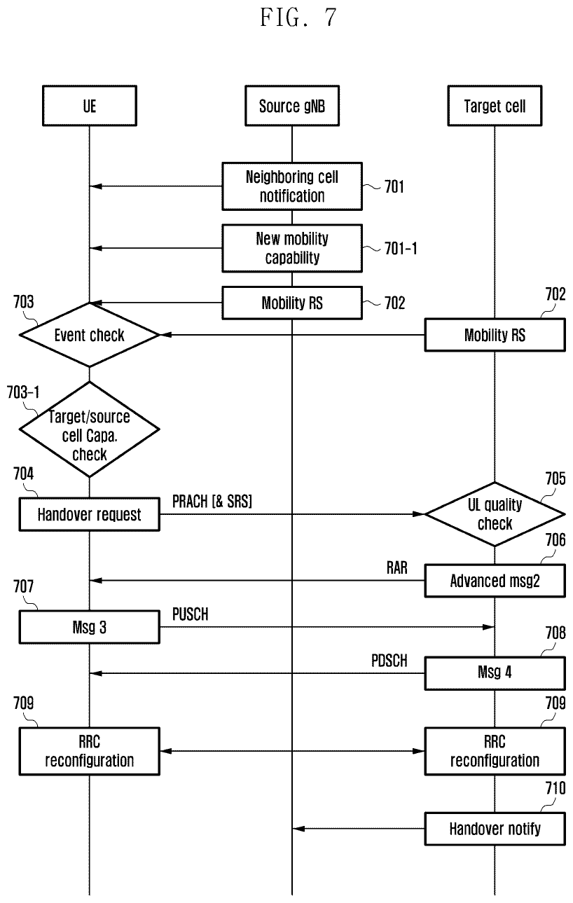

FIG. 7 is a diagram illustrating an example of a handover procedure according to one embodiment of the present disclosure. FIG. 7 illustrates an exemplary method that may be implemented according to the principles of the present disclosure, and various modifications may be made to the method illustrated in FIG. 7. For example, although illustrated as a series of steps, the various steps in each diagram may overlap, occur in parallel, occur in different orders, or occur multiple times. In other examples, steps may be omitted or replaced with other steps. Any details that overlap with the description of the handover described with reference to FIGS. 4 to 6 may be omitted, and the description of the handover described with reference to FIGS. 4 to 6 may be referred to together.

With reference to FIG. 7, the source cell may share neighboring cell information with the terminal (701). In addition, the source cell may notify the terminal of whether or not to support the target cell oriented handover process simultaneously with the neighboring cell information or as separate information (701-1).

The terminal compares the source cell DL quality and the target cell DL quality to determine whether to perform a handover, and requests the handover by transmitting a PRACH to the target cell (702 to 704). The terminal may measure the radio link quality between the terminal and the surrounding base stations. For example, the terminal may measure the radio link quality on the basis of measurements of Mobility RS for each of the source cell and target cell (702). In the case that an event that triggers a handover is identified on the basis of the measurement (703), the terminal may transmit a PRACH for a handover request to the target cell (704). Here, the terminal may identify whether the target cell and/or source cell supports the target cell oriented handover process on the basis of information about whether the target cell oriented handover process is supported (703-1) and operate accordingly. For example, in the case that the target cell supports the target cell oriented handover process, the terminal may transmit a PRACH to the target cell. In the case that the target cell oriented handover process is not supported (i.e., there are no cells that support the target cell oriented handover process), the terminal may perform the conventional handover operation.
In performing the operation, the handover request may be configured to use specific PRACH radio resources or may be defined by the standard. At least some of the RO (RACH occasion) for PRACH transmission may be configured to be used for PRACH transmission for the handover request and/or may be defined by the standard.
When performing the operation, the terminal may transmit information about the UL quality required for handover to the target cell. The terminal may transmit information about the UL quality required for handover to the target cell together with and/or separately from the PRACH transmission for the handover request. This information transmission may be omitted.
In performing the operation, the terminal may support UL quality measurement of the target cell by transmitting an additional UL quality measurement RS. The UL quality measurement RS may use sounding reference signal (SRS), but this disclosure is not limited to this, and a specific UL RS may be used. When the UL quality measurement RS is transmitted, the wireless resources used for the RS transmission may be determined by one or more of the following factors: the cell ID of the target cell, the PRACH wireless resources used in the request, or the SSB wireless resources used in selecting the PRACH wireless resources. The transmission of the UL quality measurement RS may be omitted.

The target cell recognizes the terminal's handover request by receiving the request. At the same time, UL quality measurement is performed between the terminal and the target cell on the basis of PRACH and SRS or PRACH reception (705). The target cell may receive a PRACH for a handover request from the terminal and identify the handover request of the terminal. The target cell may measure UL quality between the terminal and the target cell on the basis of the PRACH for the handover request and/or UL quality measurement RS (SRS). On the basis of the measured UL quality, the target cell may determine whether to allow the handover request of the terminal. For example, the target cell may determine whether to allow the handover request through a comparison result between the measured UL quality and a specific threshold. For example, in the case that the measured UL quality for the terminal transmitting the handover request is equal to or greater than the specific threshold, it may be determined that sufficient UL quality can be guaranteed for the terminal and a handover can be performed. In the opposite case, it may be determined not to perform the handover. The specific threshold may be a UL quality required for handover transmitted from the terminal. Alternatively, the specific threshold may be preconfigured and/or defined in a standard.

The target cell informs the terminal whether or not to accept the terminal's handover request through RAR (706). For example, the RAR may include information about whether the handover request is accepted (i.e., whether the handover is permitted). Alternatively, in the case that specific information about acceptance of the handover request is included in the RAR, it may indicate that the handover request is accepted, and in the case that it is not included, it may indicate that the handover request is not accepted. Alternatively, the transmission of the RAR itself may indicate that the target cell accepts the handover request of the terminal.
When transmitting the RAR, the target cell may transmit information about UL quality to the terminal through the RAR. The target cell may transmit information about the measured UL quality to the terminal through the RAR. In the case that the terminal transmits information about the required UL quality to the target cell in 702 to 704 described above, the target cell may omit transmitting information about UL quality to the terminal in 706. Alternatively, at the target cell's discretion, this UL quality information may be excluded from the RAR. Alternatively, in the case that information on the required UL quality is not transmitted to the target cell in 702 to 704 described above, the target cell may request the terminal to report information on the required UL quality through RAR.

The terminal transmits msg3 to the target cell through PUSCH in response to RAR (707). The terminal may also transmit information about the source cell to the target cell through this operation. For example, it transmits information that enables the target cell to define/identify the source cell, such as the source cell physical cell ID (PCID), to the target cell. This information may be transmitted through msg3 PUSCH and/or transmitted separately.

Through operation 706, the target cell transmits information about UL quality to the terminal, and in the case that the terminal determines that the UL quality is inappropriate, the terminal may transmit a handover cancelled message to the target cell through operation 707. When the terminal receives information about the measured UL quality from the target cell and determines that the received UL quality is inappropriate (for example, this may be determined by comparing the received UL quality with a specific threshold value; for example, in the case that a specific UL quality is below (or less than) or above (or exceeds) a specific threshold value, the UL quality may be determined to be inappropriate. In the opposite case, the UL quality may be determined to be appropriate. The specific threshold may be pre-configured and/or defined in a standard.), msg3 PUSCH may be used to transmit the handover cancelled message to the target cell. In the case that the handover cancelled message is transmitted to the target cell, the target cell does not perform the handover processes according to the embodiments of the present disclosure thereafter, and the handover process is terminated.

Alternatively, the terminal may transmit information about the required UL quality to the target cell through operation 707. For example, in the case that the terminal does not transmit the required UL quality information to the target cell in steps 702 to 704, it may transmit this information to the target cell through operation 707. In other words, the terminal may transmit the required UL quality information to the target cell through msg3 PUSCH.

The target cell transmits msg4 to the terminal through PDSCH in response to the terminal transmission in step 707. The target cell may transmit the final approval status of the handover to the terminal through msg4 PDSCH transmission. For example, msg4 may include information on the final approval status of the handover. Alternatively, in the case that specific information regarding approval of the handover is included in msg4, it may indicate that the handover has been approved, and in the case that it is not included, it may indicate that the handover request has not been permitted. Alternatively, the transmission of msg4 itself may indicate the target cell's approval of the terminal's handover. For example, in the case that the required UL quality received through step 707 is higher than the UL quality that the target cell can support, the target cell may reject the handover through msg4 PDSCH or inform the terminal that a reduction in UL quality is necessary. In the case that the target cell communicates to the terminal that a reduction in UL quality is necessary, it may transmit information about the reduced UL quality or the supported UL quality to the terminal through msg4 PDSCH.

Although not illustrated, after operation 707, the terminal may transmit the final approval status of the handover process to the target cell. Additionally, in the case that RRC reconfiguration is required, RRC reconfiguration operations are performed between the target cell and the terminal (709). The target cell may transmit a handover notify message to the source cell before or after performing RRC reconfiguration on the basis of the source cell information obtained through operation 707 (710). User data that was being transmitted and received through the source cell is transferred to the target cell through the transmission of the handover notify message and/or the transmission of the related message to the upper network node. In other words, the handover process may be completed without interruption time or user data buffering by the source cell.

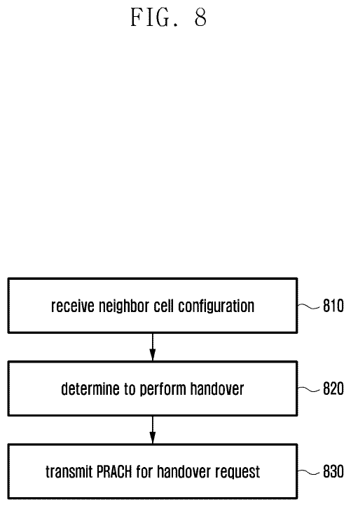

FIG. 8 is a diagram illustrating an example of the operation of a terminal according to one embodiment of the present disclosure. FIG. 8 illustrates an exemplary method that may be implemented according to the principles of the present disclosure, and various changes may be made to the method illustrated in FIG. 8. For example, although illustrated as a series of steps, the various steps in each diagram may overlap, occur in parallel, occur in different orders, or occur multiple times. In other examples, steps may be omitted or replaced with other steps.

With reference to FIG. 8, the terminal may receive a neighbor cell configuration from a source cell (810). The terminal may determine to perform a handover to a specific neighbor cell among one or more neighbor cells included in the neighbor cell configuration as the target cell (820). The terminal may transmit a PRACH for a handover request to the target cell.

For more specific details on the operation of the terminal according to one embodiment of the present disclosure described above, reference may be made to the description of various embodiments of the present disclosure described above.

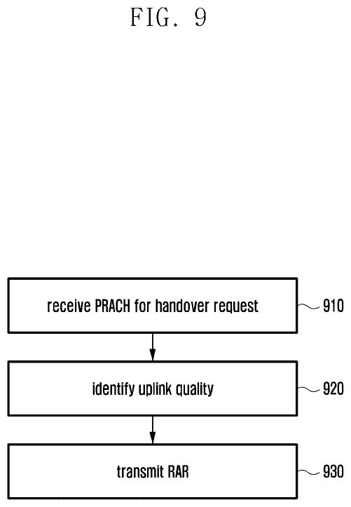

FIG. 9 is a diagram illustrating an example of the operation of a target cell according to one embodiment of the present disclosure. FIG. 9 illustrates an exemplary method that may be implemented according to the principles of the present disclosure, and various modifications may be made to the method illustrated in FIG. 9. For example, although illustrated as a series of steps, the various steps in each diagram may overlap, occur in parallel, occur in different orders, or occur multiple times. In other examples, steps may be omitted or replaced with other steps.

With reference to FIG. 9, the target cell may receive a PRACH for a handover request from the terminal (910). The target cell may identify an uplink quality related to the terminal (920). The target cell may transmit an RAR to the terminal on the basis of the identified uplink quality (930).

For more specific details on the operation of the target cell according to one embodiment of the present disclosure described above, reference may be made to the description of various embodiments of the present disclosure described above.

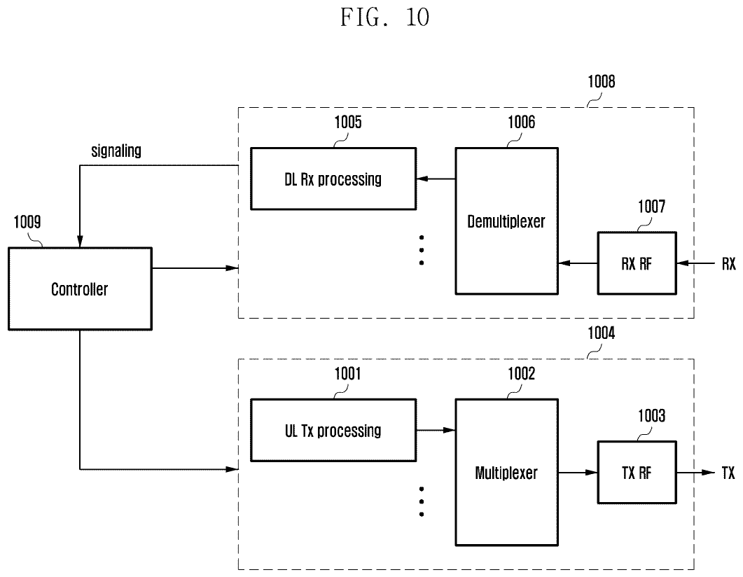

FIG. 10 illustrates a terminal transceiver according to one embodiment of the present disclosure. For convenience of explanation, the illustration and description of devices not directly related to the present disclosure may be omitted.

With reference to FIG. 10, the terminal may include a transmitter 1004 including an uplink transmission processing block 1001, a multiplexer 1002, and a transmission RF block 1003, a receiver 1008 including a downlink reception processing block 1005, a demultiplexer 1006, and a reception RF block 1007, and a controller 1009. The controller 1009 may control each of the configuration blocks of the receiver 1008 for receiving a data channel or a control channel transmitted by the base station as described above, and each of the configuration blocks of the transmitter 1004 for transmitting an uplink signal.

The uplink transmission processing block 1001 in the transmission unit 1004 of the terminal may generate a signal to be transmitted by performing processes such as channel coding and modulation. The signal generated by the uplink transmission processing block 1001 may be multiplexed with other uplink signals by the multiplexer 1002, then processed by the transmission RF block 1003, and transmitted to the base station.

The receiver 1008 of the terminal demultiplexes the signal received from the base station and distributes it to each downlink reception processing block. The downlink reception processing block 1005 performs processes such as demodulation and channel decoding on the downlink signal from the base station to obtain control information or data transmitted by the base station. The terminal receiver 1008 may supply the output results of the downlink reception processing block to the controller 1009 to support the operation of the controller 1009.

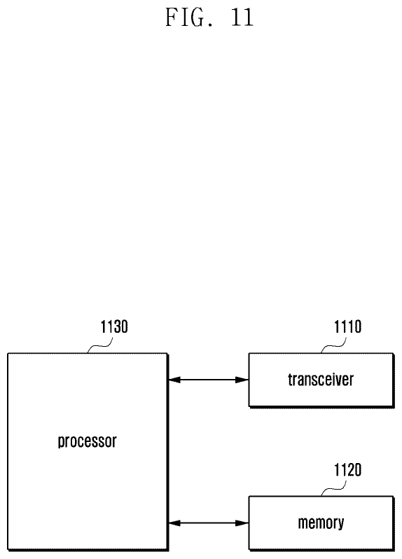

FIG. 11 is a block diagram of a terminal according to one embodiment of the present disclosure.

As illustrated in FIG. 11, the terminal of the present disclosure may include a processor 1130, a transceiver 1110, and a memory 1120. However, the components of the terminal are not limited to the examples described above. For example, the terminal may include more or fewer components than the components described above. In addition, the processor 1130, the transceiver 1110, and the memory 1120 may be implemented in the form of a single chip. According to one embodiment, the transceiver 1110 of FIG. 11 may include the transmitter 1004 and the receiver 1008 of FIG. 10. In addition, the processor 1130 of FIG. 11 may include the controller 1109 of FIG. 10.

According to one embodiment, the processor 1130 may control a series of processes that enable the terminal to operate in accordance with the aforementioned embodiment of the present disclosure. For example, it may control the components of the terminal to perform the transmission and reception methods of the terminal in accordance with the aforementioned embodiment of the present disclosure. The processor 1130 may be one or more, and the processor 1130 may perform the transmission and reception operations of the terminal according to the embodiment of the present disclosure by executing a program stored in the memory 1120.

The transceiver 1110 may transmit and receive signals with the base station. The signals transmitted and received with the base station may include control information and data. The transceiver 1110 may be composed of an RF transmitter that up-converts and amplifies the frequency of a transmitted signal, an RF receiver that low-noise amplifies a received signal and down-converts the frequency, etc. However, the transceiver 1110 is only an example, and the components of the transceiver 1110 are not limited to the RF transmitter and the RF receiver. In addition, the transceiver 1110 may receive a signal through a wireless channel and output it to the processor 1130, and transmit a signal output from the processor 1130 through the wireless channel.

According to one embodiment, the memory 1120 may store a program and data necessary for the operation of the terminal. In addition, the memory 1120 may store control information or data included in a signal transmitted and received by the terminal. The memory 1120 may be configured as a storage medium or a combination of storage media such as a ROM, a RAM, a hard disk, a CD-ROM, and a DVD. In addition, the memory 1120 may be plural. The memory 1120 may store a program for performing a transmission and reception operation of the terminal according to one embodiment of the present disclosure described above.

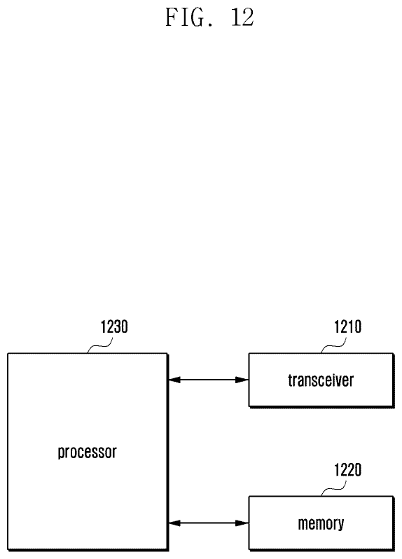

FIG. 12 is a block diagram of a base station according to one embodiment of the present disclosure.

As illustrated in FIG. 12, the base station of the present disclosure may include a processor 1230, a transceiver 1210, and a memory 1220. However, the components of the base station are not limited to the examples described above. For example, the base station may include more or fewer components than the components described above. In addition, the processor 1230, the transceiver 1210, and the memory 1220 may be implemented in the form of a single chip.

The processor 1230 may control a series of processes so that the base station can operate according to the aforementioned embodiment of the present disclosure. For example, it may control components of the base station to perform a method according to the aforementioned embodiment of the present disclosure. The processor 1230 may be one or more, and the processor 1230 may perform the method according to the aforementioned embodiment of the present disclosure by executing a program stored in the memory 1220.

The transceiver 1210 may transmit and receive signals with the terminal. The signals transmitted and received with the terminal may include control information and data. The transceiver 1210 may be configured with an RF transmitter that up-converts and amplifies the frequency of a transmitted signal, an RF receiver that low-noise amplifies a received signal and down-converts the frequency, etc. However, the transceiver 1210 is only an example, and the components of the transceiver 1210 are not limited to the RF transmitter and the RF receiver. In addition, the transceiver 1210 may receive a signal through a wireless channel and output it to the processor 1230, and transmit a signal output from the processor 1230 through the wireless channel.

According to one embodiment, the memory 1220 may store programs and data required for the operation of the base station. In addition, the memory 1220 may store control information or data included in signals transmitted and received by the base station. The memory 1220 may be configured as a storage medium or a combination of storage media such as a ROM, a RAM, a hard disk, a CD-ROM, and a DVD. In addition, there may be a plurality of memories 1220. The memory 1220 may store a program for performing the method according to an embodiment of the present disclosure described above.

The methods according to the claims or embodiments described in the specification may be implemented in the form of hardware, software, or a combination of hardware and software.

In the case of implementation by software, a computer-readable storage medium storing one or more programs (software modules) may be provided. The one or more programs stored on the computer-readable storage medium are configured for execution by one or more processors within an electronic device. The one or more programs include instructions that cause the electronic device to execute methods according to the embodiments described in the claims or specification of this disclosure.

These programs (software modules, software) may be stored in a random access memory, a non-volatile memory including a flash memory, a Read Only Memory (ROM), an Electrically Erasable Programmable Read Only Memory (EEPROM), a magnetic disc storage device, a Compact Disc-ROM (CD-ROM), a Digital Versatile Discs (DVDs) or other forms of optical storage devices, a magnetic cassette. Alternatively, they may be stored in a memory composed of a combination of some or all of these. In addition, each configuration memory may be included in multiple numbers.

Additionally, the program may be stored in an attachable storage device that is accessible through a communications network, such as the Internet, an Intranet, a Local Area Network (LAN), a Wide LAN (WLAN), or a Storage Area Network (SAN), or a combination thereof. The storage device may be connected to the device performing the embodiments of the present disclosure through an external port. Additionally, a separate storage device on the communications network may be connected to the device performing the embodiments of the present disclosure.

In the specific embodiments of the present disclosure described above, the components included in the embodiments are expressed in singular or plural form according to the specific embodiments presented. However, the singular or plural expressions are selected appropriately for the presented situation for the convenience of explanation, and the present disclosure is not limited to singular or plural components, and even components expressed in plural form may be composed of singular forms, or even components expressed in singular forms may be composed of plural forms.

Meanwhile, the embodiments of the present disclosure disclosed in this specification and drawings are only specific examples to easily explain the technical content of the present disclosure and help understand the present disclosure, and are not intended to limit the scope of the present disclosure. That is, it will be apparent to a person who has ordinary skill in the art to which the present disclosure pertains that other modified examples on the basis of the technical idea of the present disclosure are possible. In addition, the respective embodiments may be combined and operated with each other as needed. For example, portions of one embodiment of the present disclosure and another embodiment may be combined with each other to operate a base station and a terminal. For example, portions of the first embodiment and the second embodiment of the present disclosure may be combined with each other to operate a base station and a terminal.

Meanwhile, the order of description in the drawings explaining the method of the present disclosure does not necessarily correspond to the order of execution, and the order of precedence may be changed or executed in parallel.

Alternatively, the drawings illustrating the method of the present disclosure may omit some components and include only some components without damaging the essence of the present disclosure.

In addition, the method of the present disclosure may be implemented by combining portion or all of the contents included in each embodiment within a scope that does not harm the essence.

Various embodiments of the present disclosure have been described. The description of the present disclosure as described above is for illustrative purposes, and the embodiments of the present disclosure are not limited to the disclosed embodiments. Those skilled in the art to which the present disclosure pertains will understand that the present disclosure may be easily modified into other specific forms without changing the technical idea or essential features of the present disclosure. The scope of the present disclosure is indicated by the claims described below rather than the detailed description above, and all changes or modifications derived from the meaning and scope of the claims and their equivalent concepts should be interpreted as being included in the scope of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving, from a serving cell, configuration information on uplink quality measurement reference signal corresponding to a neighbor cell;
identifying that a mobility to the neighbor cell is triggered;
transmitting, to the neighbor cell, the uplink quality measurement reference signal based on the configuration information; and
receiving, from the neighbor cell, a first response message associated with whether the mobility is available, wherein whether the mobility is available is based on uplink quality corresponding to the uplink quality measurement reference signal.

2. The method of claim 1, wherein the first response message includes an explicit indication indicates whether the mobility is allowed by the neighbor cell,
wherein in case that the uplink quality is equal to or higher than a first threshold, the explicit indication indicates that the mobility is allowed by neighbor cell,
wherein in case that the uplink quality is lower than the first threshold, the explicit indication indicates that the mobility is not allowed by neighbor cell, and
wherein a value of the first threshold is predefined or information on the value of the first threshold is transmitted with the uplink quality measurement reference signal.

3. The method of claim 1, wherein the first response message includes information on the uplink quality.

4. The method of claim 3, further comprising:
in case that the uplink quality is equal to or higher than a second threshold:
transmitting, to the neighbor cell, a handover confirmation message; and
receiving, from the neighbor cell, a second response message associated with whether the handover is approved; and
in case that the uplink quality is lower than the second threshold, transmitting, to the neighbor cell, a handover cancellation message,
wherein a value of the second threshold is predefined or autonomously determined by the UE, or information on the value of the second threshold is received from the serving cell.

5. The method of claim 4, wherein the uplink quality measurement reference signal corresponds to a physical random access channel (PRACH) or a sounding reference signal (SRS),
wherein the first response message corresponds to a random access response (RAR),
wherein the handover confirmation message or the handover cancellation message is transmitted in a message 3 physical uplink shared channel (PUSCH) scheduled by the RAR, and
wherein the second response message is received in a message 4 physical downlink shared channel (PDSCH).

6. The method of claim 1, wherein the configuration information includes information on at least one uplink quality measurement reference signal resource corresponding to the neighbor cell, and
wherein the mobility to the neighbor cell being triggered is identified based on radio link quality measurements for mobility reference signals received from the serving cell and the neighbor cell.

7. A user equipment (UE) in a communication system, the UE comprising:
a transceiver; and
a processor coupled with the transceiver and configured to:
receive, from a serving cell, configuration information on uplink quality measurement reference signal corresponding to a neighbor cell;
identify that a mobility to the neighbor cell is triggered;
transmit, to the neighbor cell, the uplink quality measurement reference signal based on the configuration information; and
receive, from the neighbor cell, a first response message associated with whether the mobility is available, wherein whether the mobility is available is based on uplink quality corresponding to the uplink quality measurement reference signal.

8. The UE of claim 7, wherein the first response message includes an explicit indication indicating whether the mobility is allowed by the neighbor cell,
wherein in case that the uplink quality is equal to or higher than a first threshold, the explicit indication indicates that the mobility is allowed by neighbor cell,
wherein in case that the uplink quality is lower than the first threshold, the explicit indication indicates that the mobility is not allowed by neighbor cell, and
wherein a value of the first threshold is predefined or information on the value of the first threshold is transmitted with the uplink quality measurement reference signal.

9. The UE of claim 7, wherein the first response message includes information on the uplink quality.

10. The UE of claim 9, wherein the processor is further configured to:
in case that the uplink quality is equal to or higher than a second threshold:
transmit, to the neighbor cell, a handover confirmation message; and
receive, from the neighbor cell, a second response message associated with whether the handover is approved; and
in case that the uplink quality is lower than the second threshold, transmit, to the neighbor cell, a handover cancellation message,
wherein a value of the second threshold is predefined or autonomously determined by the UE, or information on the value of the second threshold is received from the serving cell.

11. The UE of claim 10, wherein the uplink quality measurement reference signal corresponds to a physical random access channel (PRACH) or a sounding reference signal (SRS),
wherein the first response message corresponds to a random access response (RAR),
wherein the handover confirmation message or the handover cancellation message is transmitted in a message 3 physical uplink shared channel (PUSCH) scheduled by the RAR, and
wherein the second response message is received in a message 4 physical downlink shared channel (PDSCH).

12. The UE of claim 7, wherein the configuration information includes information on at least one uplink quality measurement reference signal resource corresponding to the neighbor cell, and
wherein the mobility to the neighbor cell being triggered is identified based on radio link quality measurements for mobility reference signals received from the serving cell and the neighbor cell.

13. A method performed by a base station in a communication system, the method comprising:
transmitting, to a user equipment (UE) on a serving cell, configuration information on uplink quality measurement reference signal corresponding to a neighbor cell;
receiving, from the UE on the neighbor cell, the uplink quality measurement reference signal associated with the configuration information;
identifying uplink quality based on the uplink quality measurement reference signal; and
transmitting, to the UE on the neighbor cell, a first response message associated with whether a mobility is available, wherein whether the mobility is available is based on the uplink quality.

14. The method of claim 13, wherein the first response message includes an explicit indication indicates whether the mobility is allowed by the neighbor cell,
wherein in case that the uplink quality is equal to or higher than a first threshold, the explicit indication indicates that the mobility is allowed by neighbor cell,
wherein in case that the uplink quality is lower than the first threshold, the explicit indication indicates that the mobility is not allowed by neighbor cell, and
wherein a value of the first threshold is predefined or information on the value of the first threshold is received with the uplink quality measurement reference signal.

15. The method of claim 13, wherein the first response message includes information on the uplink quality.

16. The method of claim 13, further comprising:
in case that the uplink quality is equal to or higher than a second threshold:
receiving, from the UE on the neighbor cell, a handover confirmation message; and
transmitting, to the UE on the neighbor cell, a second response message associated with whether the handover is approved; and
in case that the uplink quality is lower than the second threshold, receiving, from the UE on the neighbor cell, a handover cancellation message,
wherein a value of the second threshold is predefined or autonomously determined by the UE, or information on the value of the second threshold is transmitted to the UE on the serving cell.

17. A base station in a communication system, the base station comprising:
a transceiver; and
a processor coupled with the transceiver and configured to:
transmit, to a user equipment (UE) on a serving cell, configuration information on uplink quality measurement reference signal corresponding to a neighbor cell;
receive, from the UE on the neighbor cell, the uplink quality measurement reference signal associated with the configuration information;
identify uplink quality based on the uplink quality measurement reference signal; and
transmit, to the UE on the neighbor cell, a first response message associated with whether a mobility is available, wherein whether the mobility is available is based on the uplink quality.

18. The base station of claim 17, wherein the first response message includes an explicit indication indicates whether the mobility is allowed by the neighbor cell,
wherein in case that the uplink quality is equal to or higher than a first threshold, the explicit indication indicates that the mobility is allowed by neighbor cell,
wherein in case that the uplink quality is lower than the first threshold, the explicit indication indicates that the mobility is not allowed by neighbor cell, and
wherein a value of the first threshold is predefined or information on the value of the first threshold is received with the uplink quality measurement reference signal.

19. The base station of claim 17, wherein the first response message includes information on the uplink quality.

20. The base station of claim 17, wherein the processor is further configured to:
in case that the uplink quality is equal to or higher than a second threshold:
receive, from the UE on the neighbor cell, a handover confirmation message; and
transmit, to the UE on the neighbor cell, a second response message associated with whether the handover is approved; and
in case that the uplink quality is lower than the second threshold, receive, from the UE on the neighbor cell, a handover cancellation message,
wherein a value of the second threshold is predefined or autonomously determined by the UE, or information on the value of the second threshold is transmitted to the UE on the serving cell.
